(19) United States
(12) Patent Application Publication
(10) Pub. No.: US 2014/0043158 A1
(43) Pub. Date: Feb. 13, 2014

(54) Debo alarm system second phase (D.A.S.S.P.)

(71) Applicant: Durwin Keith Lasker, Conway, AR (US)

(72) Inventor: Durwin Keith Lasker, Conway, AR (US)

(21) Appl. No.: 13/986,106

(22) Filed: Apr. 1, 2013

Related U.S. Application Data
(60) Provisional application No. 61/742,477, filed on Aug. 13, 2012.

(51) Int. Cl. G08B 1/08

(52) U.S. Cl. CPC G08B 1/08
USPC 340/501; 340/533; 340/693.2; 340/547; 340/545.1; 340/541; 340/557

(57) ABSTRACT

Debo Alarm System Second Phase (D.A.S.S.P.) is a mobile Security System for the Home, Apartment, RV, Commercial Businesses, and Vacation Suite etc. . . . This alarm system is unique because it utilizes the existing wiring in the area you are trying to secure. The system works like a traditional alarm system with 911 and Carbon Monoxide function. This system not only has the ability to monitor the inside of your home it also allows you to monitor the perimeter of your home. The Debo Alarm System Second Phase has a detachable Mobile Module with 911 and Carbon Monoxide function. The Mobile Module can be used to monitor your home system and protect you at a second location. The Mobile Module can be plugged into a wall socket like a cell phone. The Mobile Module has an internal rechargeable battery to allow a wide range of security functions.

This is base on Provisional Patent No. 61/742,477 filed on the date of Aug. 13, 2012.

### BACKGROUND OF THE INVENTION

### SUMMARY OF THE INVENTION

The Debo Alarm System Second Phase gives the everyday consumer the ability to protect their family, self and property. The second phase gives the everyday consumer the ability to protect their family when they are on vacation. The Debo Alarm System Second Phase will still protect your home while you are on vacation. The system targets college students, single individuals and family who have a limited income resource. It allows them the ability to afford and possess a security device without the overhead cost of installation and monthly expense. The key function of this system is the ability to have security away from home at a resort, worksite, car, campsite etc. . . . and still be ability to secure, monitor and arm your dwelling with a mobile module. The system is manufactured to monitor the perimeter of your home. The Debo Alarm System Second Phase can alert you when someone drives down your driveway, open your front or back gate, even when someone steps on your property. It also has use in a wide range of commercial applications. It is flexible, portable system, made to provide a number of security functions from alert the authorities and you to the damages of carbon monoxide levels. This is a serious alarm system without the serious overhead cost. This alarm system is unique because it utilizes the existing wiring in the area you are trying to secure.

### BRIEF DESCRIPTION OF DRAWINGS

FIG. 1 is a perspective view of the front of the Debo Alarm System's Second Phase Keypad in Letter mode with detachable Mobile Module.

FIG. 2 is a perspective view of the front of the Debo Alarm System's Second Phase Keypad in Number/Symbol mode with detachable Mobile Module.

FIG. 3 is a perspective view of the front of the Debo Alarm System's Second Phase Keypad with the Mobile Module detached.

FIG. 4 is a perspective view of the back and side of the Debo Alarm System's Second Phase Keypad.

FIG. 5 is a perspective view of the front, back, side and top of the Mobile Module.

FIG. 6 is a perspective view of the front, top and side of the Debo Alarm System's Second Phase Motion Detector with the top view of the motion detector's adaptor. The detector's adaptor is stuck on the back of the motion detector to fit in the corner of a room.

FIG. 7 is a perspective view of the top of the Debo Alarm System's Second Phase Base that houses the keypad. The Base is installed where the central light switch is located.

FIG. 8 is a perspective view of the left side of the Debo Alarm System's Second Phase Base that houses the keypad. The Base is installed where the central light switch is located.

FIG. 9 is a perspective view of the top of the Debo Alarm System's Second Phase Base that houses the keypad. The Base is installed where the central light switch is located.

FIG. 10 is a perspective view of the back of the Debo Alarm System's Second Phase Base that houses the keypad. The Base is installed where the central light switch is located.

FIG. 11 is a perspective view of the front of the Debo Alarm System's Second Phase Base that houses the keypad. The Base is installed where the central light switch is located.

FIG. 12 is a perspective view of the Debo Alarm System's Second Phase Magnet and Receiver which are movable or stationary devices.

FIG. 13 is a perspective view of the top, front and side Debo Alarm System's Second Phase Perimeter Sensor. The Perimeter Sensor for the Debo Alarm System's Second Phase can be used to setup a perimeter around your House, Worksite, Campsite etc. . . .

### DETAILED DESCRIPTION OF THE DEBO ALARM SYSTEM SECOND PHASE (D.A.S.S.P.)

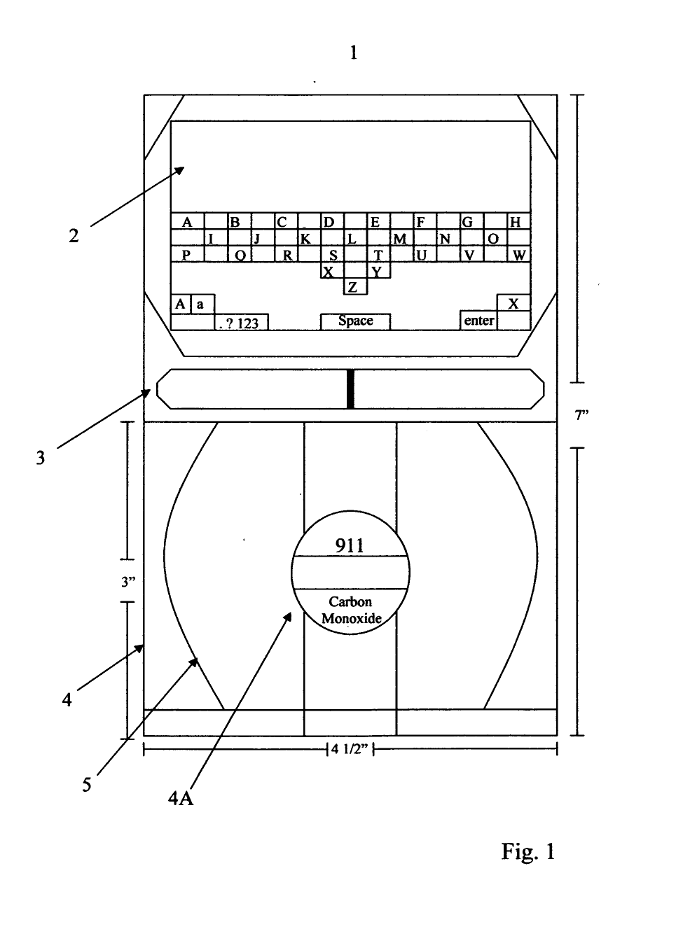

As shown in FIG. 1, front of the Debo Alarm System's Second Phase Keypad in Letter mode with detachable Mobile Module. 1, front view of the Debo Alarm System's Keypad with detachable Mobile Module. 2, digital touch screen display (digital touch screen display can be changed to Letter mode to Number/Symbol mode)allows you to enter your information so it can be displayed on the 911 operators terminal. You can enter the number of people living in the dwelling. You can enter a safety code and three phone numbers to be contacted in case of an emergency. The unique feature of entering your specific location is important to your security. If you live in a multiplex, you can enter your specific apartment location. You can enter in if you live on the bottom, top, right-side, left-side or next to a structure. 3, two speaker to project intense sound when the alarm is triggered. 4, Mobile Module can be detached from the main system. The Mobile Module can be taken with you and your family on vacation, to a friend house etc. . . . The mobile module can protect you while you are away from your dwelling. The Debo Alarm System protects your dwelling while you are away. The Debo Alarm System and the mobile module has 911 function and a Carbon Monoxide detector. When an intruder breaks into your dwelling the Debo Alarm System alerts you and calls 911. The mobile module will not call 911 unless you have pre-programmed it to do so. The function has to be done while the mobile module is in the Debo Alarm System. You do not have to pre-program the carbon monoxide function to work. 4A, 911 and a Carbon Monoxide Detector. 5, two speaker to project intense sound and to alert you when there is a breach in your secure areas.

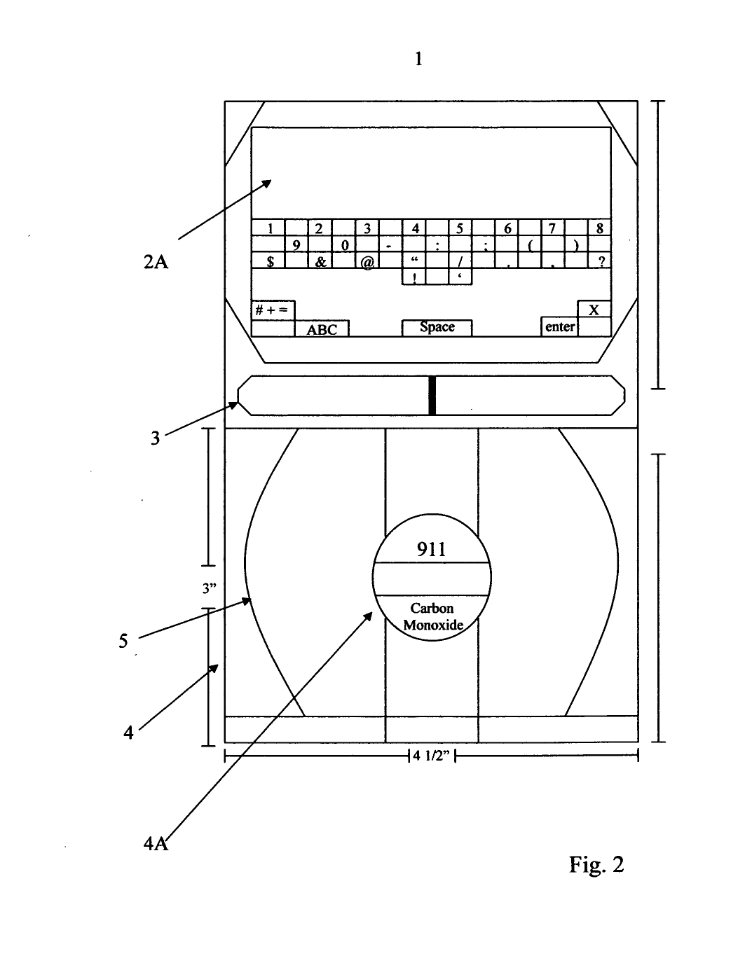

As shown in FIG. 2, front of the Debo Alarm System's Second Phase Keypad in Number/Symbol mode with detachable Mobile Module. 1, front view of the Debo Alarm System's Keypad with detachable Mobile Module. 2A, digital touch screen display (digital touch screen display can be changed to Letter mode to Number/Symbol mode)allows you to enter your information so it can be displayed on the 911 operators terminal. You can enter the number of people living in the dwelling. You can enter a safety code and three phone numbers to be contacted in case of an emergency. The unique feature of entering your specific location is important to your security. If you live in a multiplex, you can enter your specific apartment location. You can enter in if you live on the bottom, top, right-side, left-side or next to a structure. 3, two speaker to project intense sound when the alarm is triggered. 4, Mobile Module can be detached from the main system. The Mobile Module can be taken with you and your family on vacation, to a friend house etc. . . . The mobile module can protect you while you are away from your dwelling. The Debo Alarm System protects your dwelling while you are away. The Debo Alarm System and the mobile module has 911 function and a Carbon Monoxide detector. When an intruder breaks into your dwelling the Debo Alarm System alerts you and calls 911. The mobile module will not call 911 unless you have pre-programmed it to do so. The function has to be done while the mobile module is in the Debo Alarm System. You do not have to pre-program the carbon monoxide function to work. 4A, 911 and a Carbon Monoxide Detector. 5, two speaker to project intense sound and to alert you when there is a breach in your secure areas.

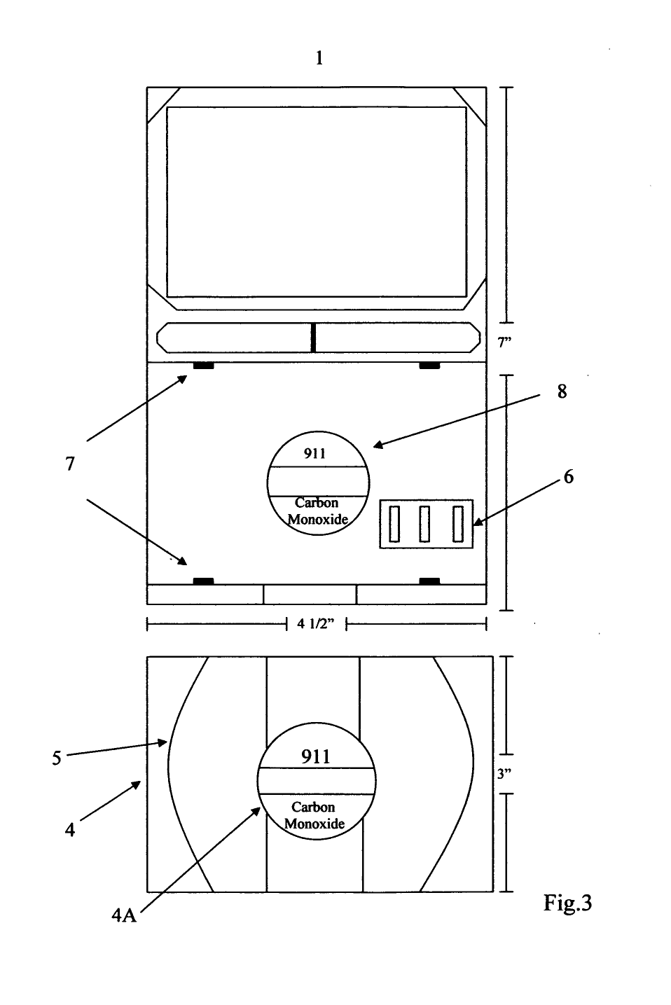

As shown in FIG. 3 front of the Debo Alarm System's Second Phase Keypad with detachable Mobile Module. 1, front view of the Debo Alarm System's Keypad with detachable Mobile Module. 2B, digital touch screen display (digital touch screen display can be changed to Letter mode to Number /Symbol mode)allows you to enter your information so it can be displayed on the 911 operators terminal. You can enter the number of people living in the dwelling. You can enter a safety code and three phone numbers to be contacted in case of an emergency. The unique feature of entering your specific location is important to your security. If you live in a multiplex, you can enter your specific apartment location. You can enter in if you live on the bottom, top, right-side, left-side or next to a structure. 3, two speaker to project intense sound when the alarm is triggered. 4, Mobile Module can be detached from the main system. The Mobile Module can be taken with you and your family on vacation, to a friend house etc. . . . The mobile module can protect you while you are away from your dwelling. The Debo Alarm System protects your dwelling while you are away. The Debo Alarm System and the mobile module has 911 function and a Carbon Monoxide detector. When an intruder breaks into your dwelling the Debo Alarm System alerts you and calls 911. The mobile module will not call 911 unless you have pre-programmed it to do so. The function has to be done while the mobile module is in the Debo Alarm System. You do not have to pre-program the carbon monoxide function to work. 4A, 911 and a Carbon Monoxide Detector. 5, two speaker to project intense sound and to alert you when there is a breach in your secure areas. 6, powers the Mobile Module when it attached to the Debo Alarm System. It is also used as the data and information connection. 7, snaps to hold the mobile module into place. 8, the Debo Alarm System's Second Phase has a 911 and Carbon Monoxide function when the Mobile Module is detached.

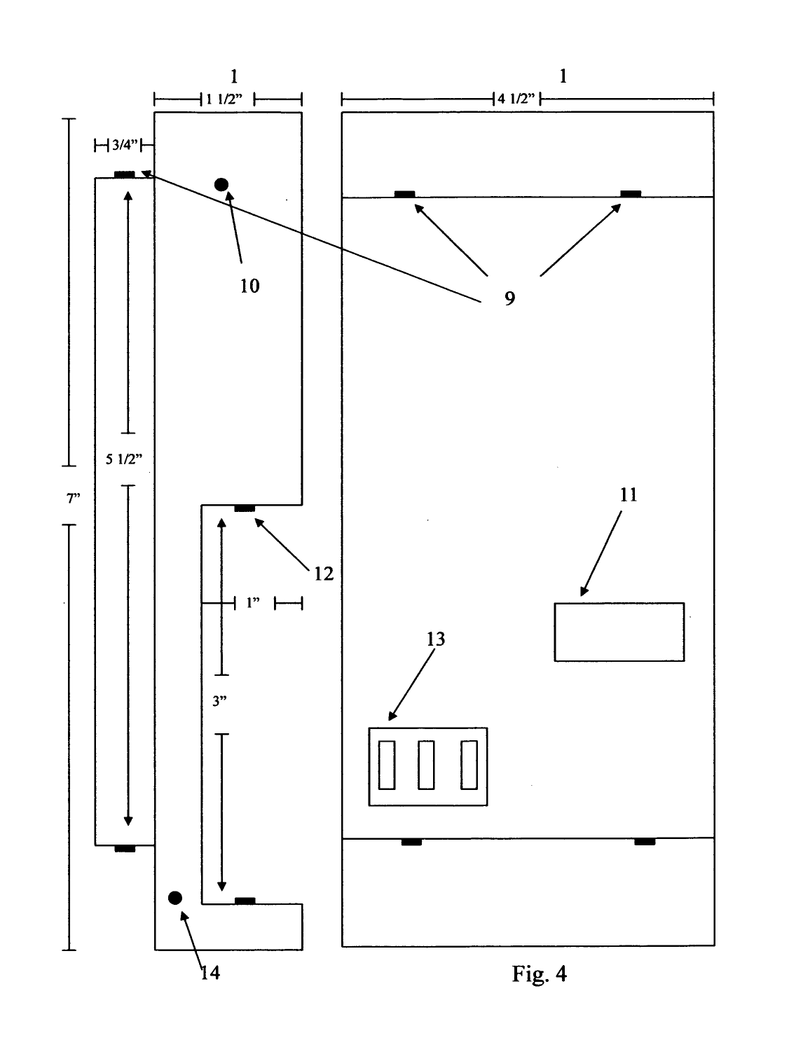

As shown in FIG. 4 back and side of the Debo Alarm System's Second Phase Keypad without the Mobile Module. 1, back and side view of the Debo Alarm System's Second Phase Keypad. 9, snaps to hold the Debo Alarm System's Keypad in the base. 10, re-set button helps you to change information like: password, address, location, security code etc. . . . 11, internal rechargeable battery in case power lost or if the system is temper with. The system has the ability to contact 911 or home owner to a breach in the system. 12, snaps to hold the mobile module into place. 13, transfer data and information from the Debo Alarm System's Base to the Keypad. 14, ac/dc adaptor can be used to recharge the internal battery. Debo Alarm System's Second Phase can plugged into a car, rv, camper etc. . . . Whatever you want to secure.

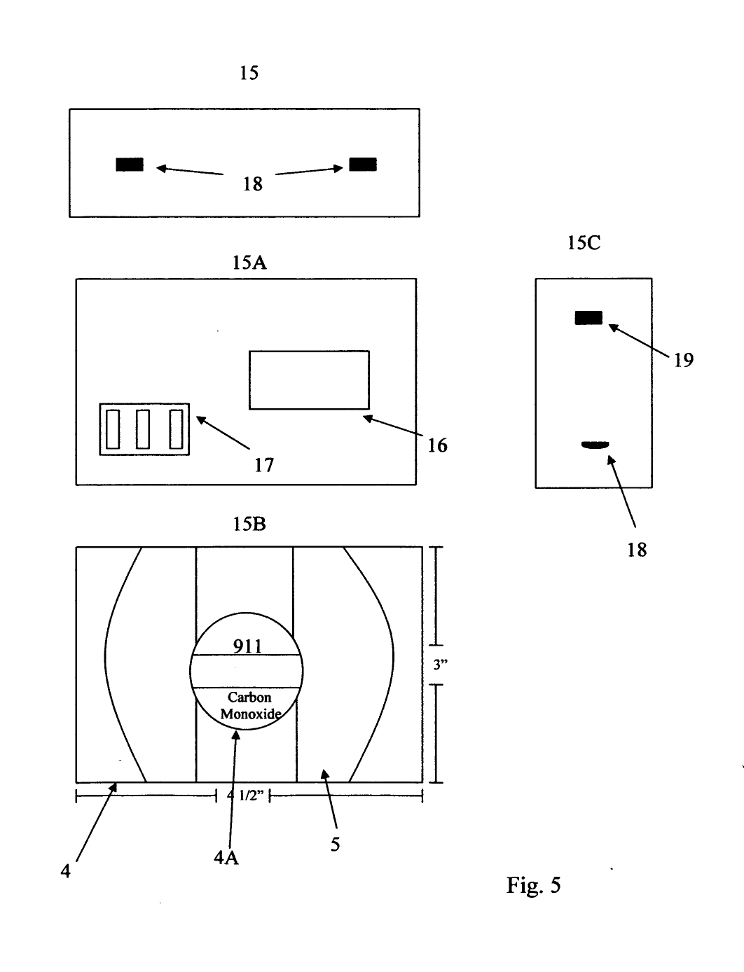

As shown in FIG. 5 front, back, side and top of the Debo Alarm System's Second Phase Mobile Module. 4, Mobile Module can be detached from the main system. The Mobile Module can be taken with you and your family on vacation, to a friend house etc. . . . The mobile module can protect you while you are away from your dwelling. The Debo Alarm System protects your dwelling while you are away. The Debo Alarm System and the mobile module has 911 function and a Carbon Monoxide detector. When an intruder breaks into your dwelling the Debo Alarm System alerts you and calls 911. The mobile module will not call 911 unless you have pre-programmed it to do so. The function has to be done while the mobile module is in the Debo Alarm System. You do not have to pre-program the carbon monoxide function to work. 4A, 911 and a Carbon Monoxide Detector. 5, two speaker to project intense sound and to alert you when there is a breach in your secure areas. 15, top view of the Mobile Module. 15A, back view of the Mobile Module. 15B, front view of the Mobile Module. 15C, side view of the Mobile Module. 16, internal rechargeable battery. The Mobile Module is used to secure you or property at a second location. 17, used to send data and information to the Mobile Module from the keypad. If the alarm is triggered the 911 function will work if the pre-program function was done when the mobile module was attached to the Debo Alarm System. 18, ac/dc adaptor. The Mobile Module can be recharged through the ac/dc adaptor. 19, monitor set button is used to activate the monitors. The mobile module can be used to protect you and your family while you are on vacation. Place monitors on the windows and doors you want to secure. Push and hold the monitor set button like you would do a Bluetooth. When the mobile module beeps the device is ready to protect. The mobile module security code is set by how many times you push the Carbon Monoxide button. Push the monitor set button first then set your security code. Once you have set your alarm, you have a ten second delay before the system is armed. 20, slots to hold the Debo Alarm System's Mobile Module in the Keypad.

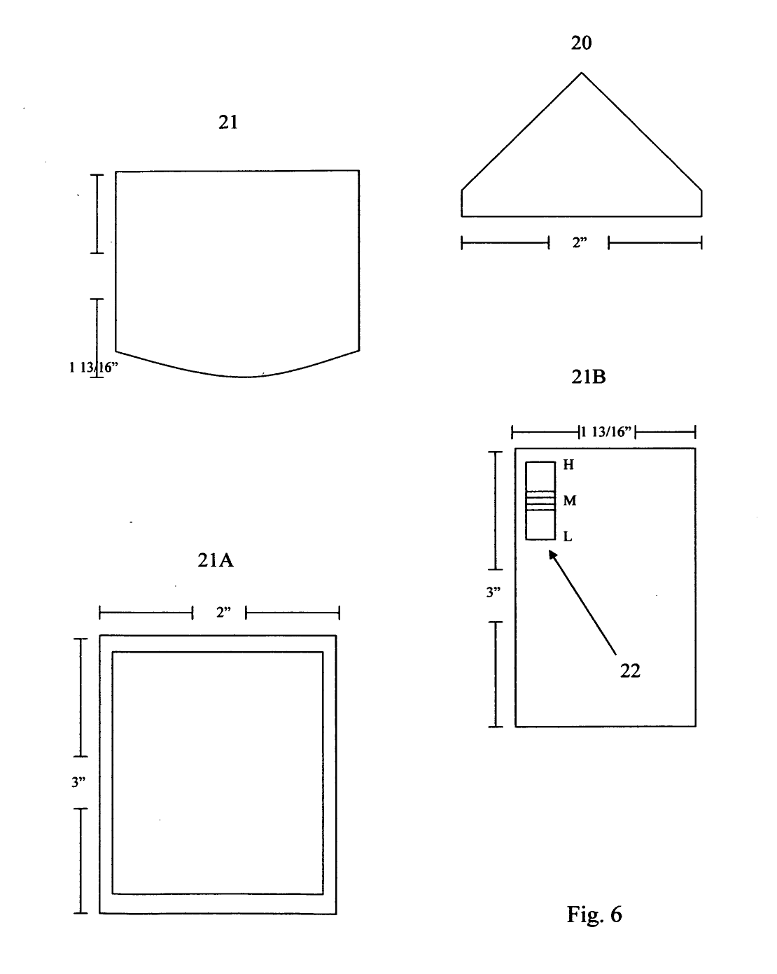

As shown in FIG. 6 front, top and side of the Debo Alarm System's Second Phase Motion Detector with the top view of the motion detector's adaptor. The detector's adaptor is stuck on the back of the motion detector to fit in the corner of a room. 20, top view of the detector's adaptor. The adaptor allow you to change the back of the detector so the motion detector can be put in the corner of a room. 21, top view of the motion detector. 21A, front view of the Motion Detector. The front of the Motion Detector alerts the alarm system to movement. The Debo Alarm System's Second Phase motion detector need to placed in areas an intruder will cross to gain access to the rest of your dwelling. You can set the motion detectors to monitor specific areas of your dwelling while you are at or away from home. 21B, side view of the motion detector. 22, Sensitivity Switch w/High, Medium and Low settings on the motion detector.

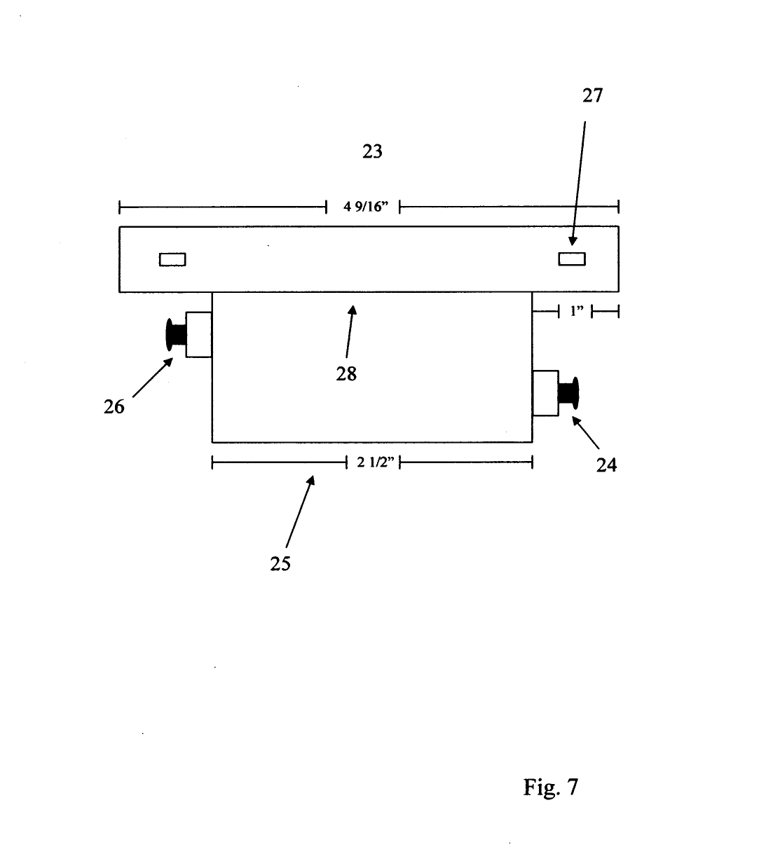

As shown in FIG. 7 top view of the Debo Alarm System's Second Phase Base. 23, top view of the Debo Alarm System's Second Phase showing measurements of the Base. 24, is the positive connection to connect the positive wire in the light switch area. 25, is an internal rechargeable battery in case the power in the area you are trying to secure goes out. 26, is the negative connection to connect the negative wire in the light switch area. 27, is a slot to snap the keypad into the base. 28, is a screw hole.

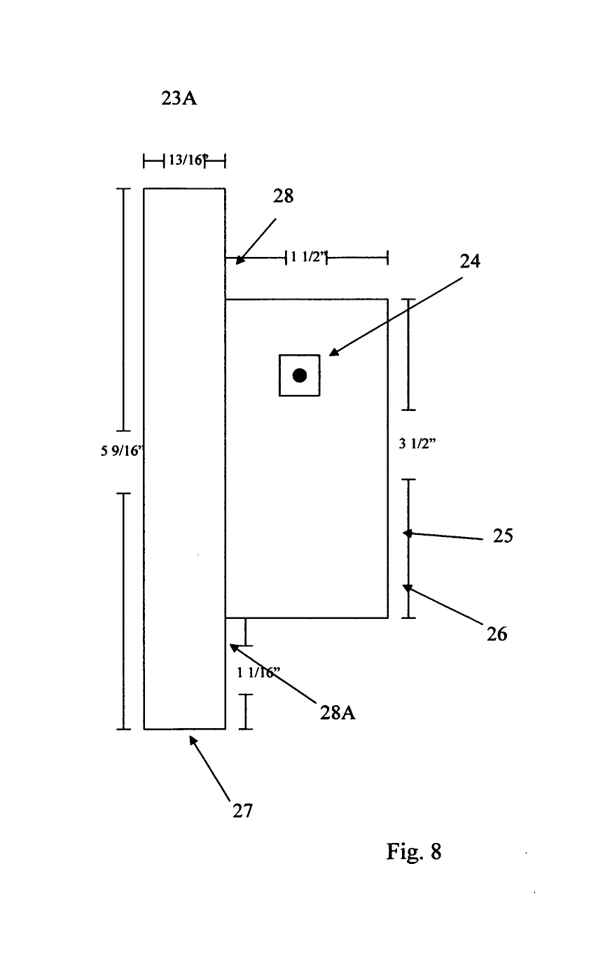

As shown in FIG. 8 left-side view of the Debo Alarm System's Second Phase Base. 23A, left-side view of the Debo Alarm System's Second Phase showing measurements of the Base. 24, is the positive connection to connect the positive wire in the light switch area. 25, is an internal rechargeable battery in case the power in the area you are trying to secure goes out. 26, is the negative connection to connect the negative wire in the light switch area. 27, is a slot to snap the keypad into the base. 28, is a screw hole. 28A, is a screw hole.

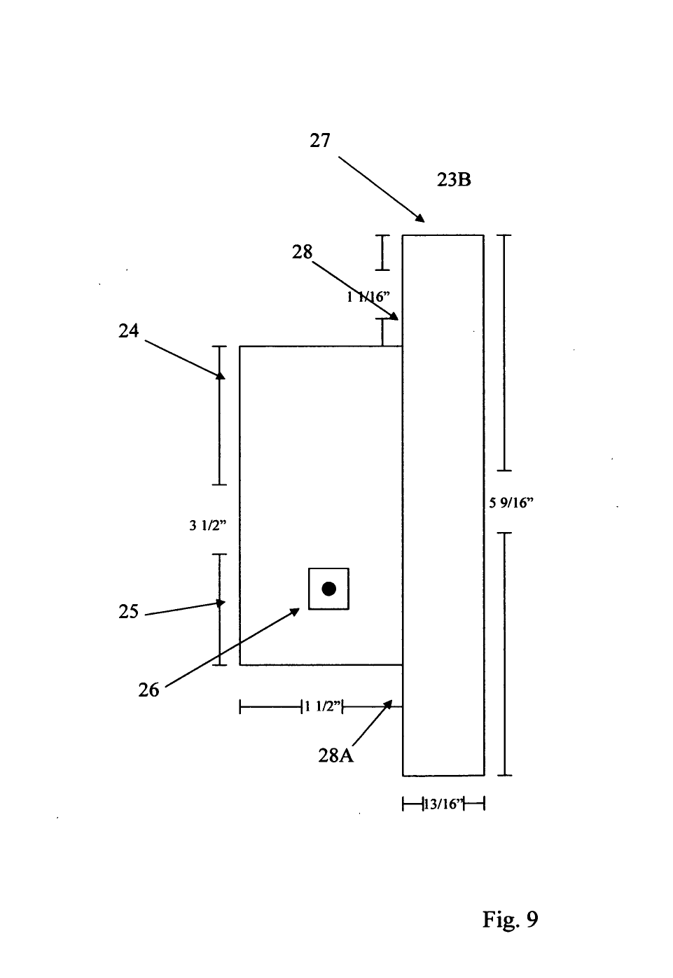

As shown in FIG. 9 right-side view of the Debo Alarm System's Second Phase Base. 23B, right-side view of the Debo Alarm System's Second Phase showing measurements of the Base. 24, is the positive connection to connect the positive wire in the light switch area. 25, is an internal rechargeable battery in case the power in the area you are trying to secure goes out. 26, is the negative connection to connect the negative wire in the light switch area. 27, is a slot to snap the keypad into the base. 28, is a screw hole. 28A, is a screw hole.

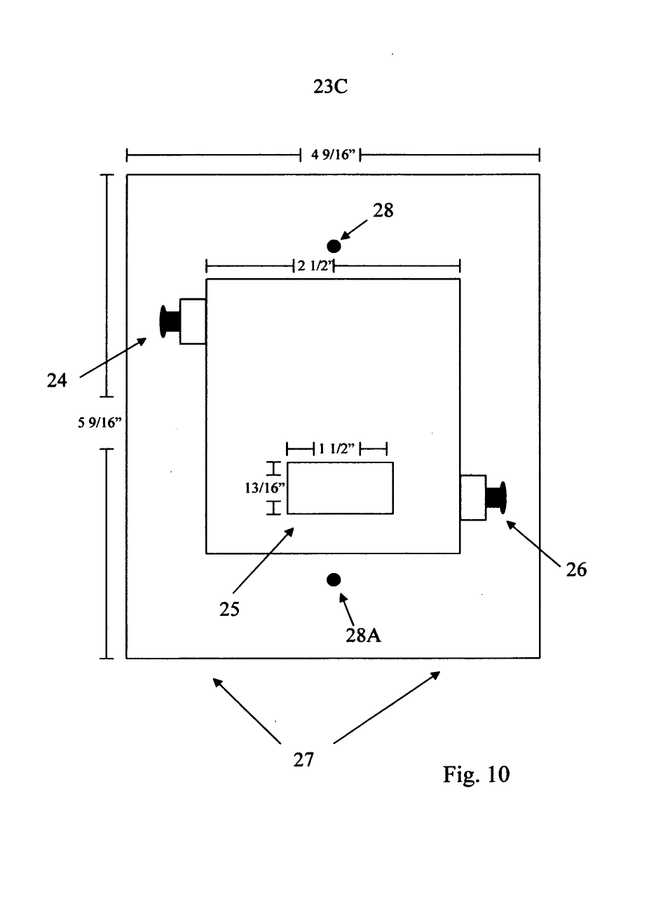

As shown in FIG. 10 back view of the Debo Alarm System's Second Phase Base. 23C, back view of the Debo Alarm System's Second Phase showing measurements of the Base. 24, is the positive connection to connect the positive wire in the light switch area. 25, is an internal rechargeable battery in case the power in the area you are trying to secure goes out. 26, is the negative connection to connect the negative wire in the light switch area. 27, is a slot to snap the keypad into the base. 28, is a screw hole. 28A, is a screw hole.

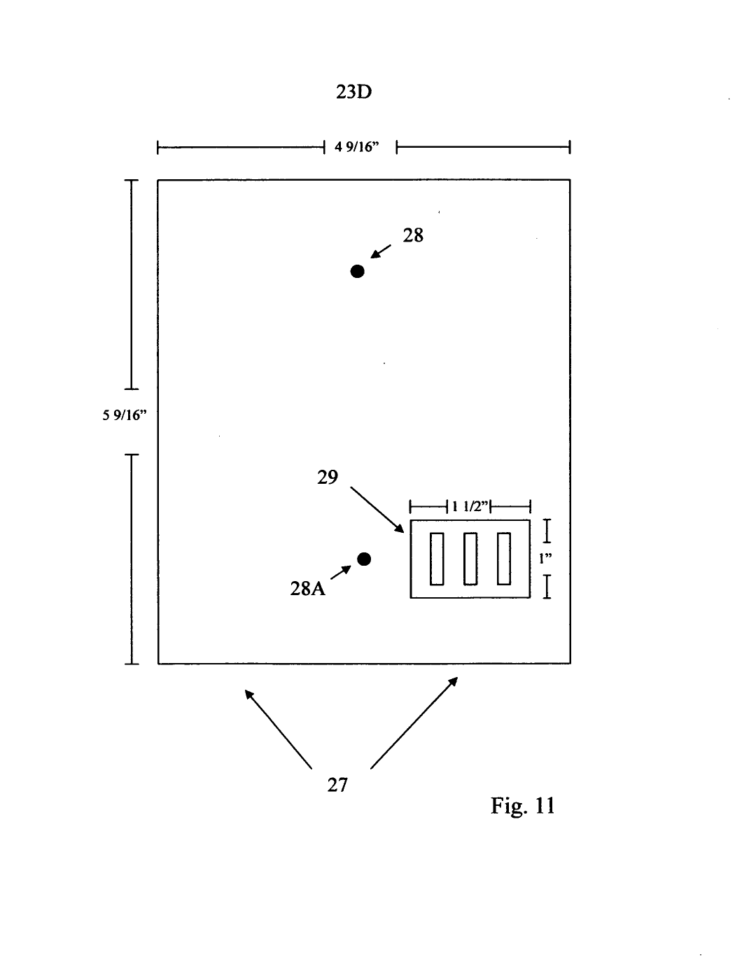

As shown in FIG. 11 front view of the Debo Alarm System's Second Phase Base. 23D, front view of the Debo Alarm System's Second Phase showing measurements of the Base. 28, is a screw hole. 28A, is a screw hole. 29, is the power, data and information connection which helps power the keypad.

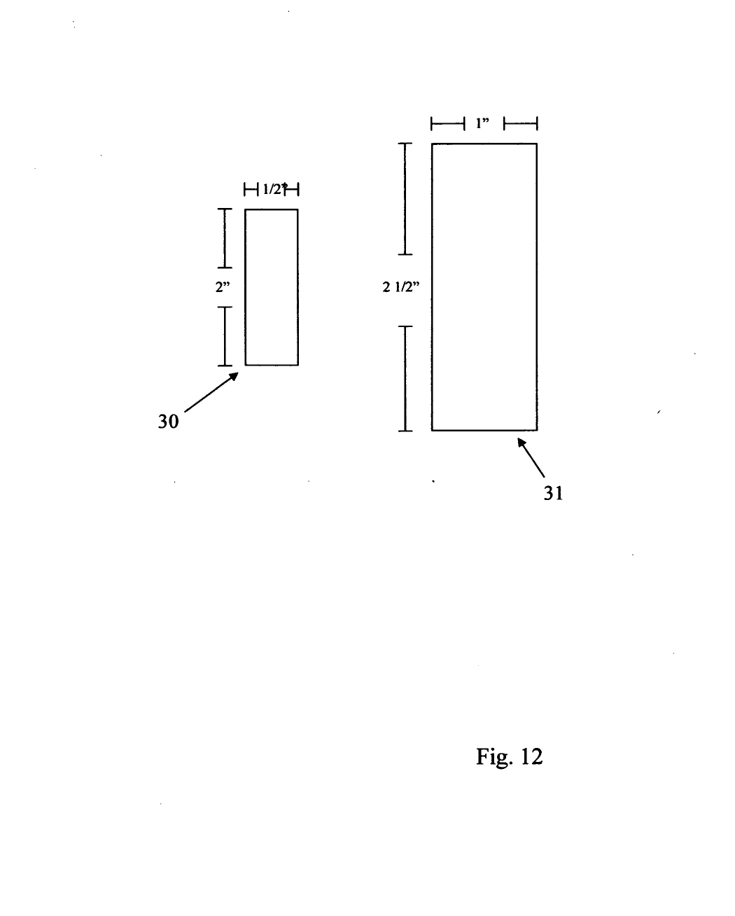

As shown in FIG. 12, Magnet and Receiver which are movable or stationary devices which helps alert the Debo Alarm System when the area you are trying to secure, becomes unsecure. 30, is a magnet which is placed on the doors or windows (movable or stationary device). 31, is a receiver which is placed on the doors or windows (movable or stationary device).

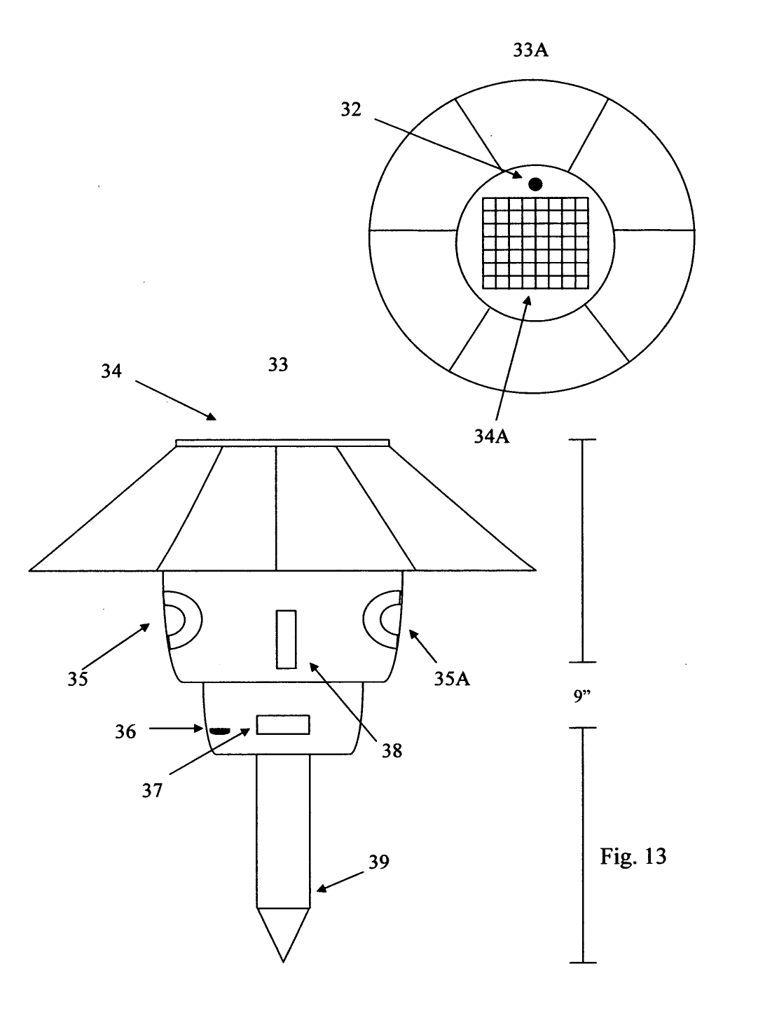

As shown in FIG. 13, front, side and top view of the Debo Alarm System's Second Phase Perimeter Sensor. 32, set perimeter button is used to link up the Perimeter Sensor. 33, front and side view of the Perimeter Sensor with measurement. 33A, top view of the Perimeter Sensor showing the set perimeter button and solar panel. 34, solar panel keeps the sensor working on its own power source. 34A, top view of the solar panel. After the rechargeable is fully charged the Perimeter Sensor will work though out the night. 35, receiver is linked to the laser and when the connection is broken the system will alert you to the breach. 35A, laser is linked to the receiver and when the connection is broken the system will alert you to the breach. 36, ac/dc adapter can charge the mobile module or your cell phone when you are camping. The Perimeter Sensor has enough power to charge a laptop computer when the sun is out. 37, internal rechargeable battery will keep the Perimeter Sensor at night. 38, light and motion detector to alert the system to movement in your perimeter. 39, stake the Perimeter Sensor where you want to establish your perimeter.

### INSTRUCTION ON HOW TO INSTALL THE DEBO ALARM SYSTEM SECOND PHASE (D.A.S.S.P.)

The Debo Alarm System Second Phase comes in seven parts:

1. The D.A.S.S.P. Keypad allows you to enter your information so it can be displayed on the 911 operators terminal. You can enter the number of people living in the dwelling. You can enter a safety code and three phone numbers to be contacted in case of an emergency. The unique feature of entering your specific location is important to your security. If you live in a multiplex, you can enter your specific apartment location. You can enter in if you live on the bottom, top, right-side, left-side or next to a structure. The Debo Alarm System allows you to monitor who drives down your driveway, when your front or back gate is open. You can monitor different parts of your dwelling with motion detectors. You can monitor, arm and disarm the Debo Alarm System with the detachable mobile module. The Debo Alarm System and mobile module has 911 and Carbon Monoxide function abilities together or separate. The Debo Alarm System and mobile module has internal rechargeable batteries in case the power goes out. The Debo Alarm System is an all inclusive alarm system with no install or month to month expense. The alarm system relocates when you relocate.

2. The Debo Alarm System has a Mobile Module you can detach from the main system. The mobile module can be taken with you and your family on vacation, to a friend's house etc. . . . The mobile module can protect you while you are away from your dwelling. The Debo Alarm System protects your dwelling while you are away. The Debo Alarm System and the mobile module has 911 function and a Carbon Monoxide detector. When an intruder breaks into your dwelling the Debo Alarm System alerts you and calls 911. The mobile module will not call 911 unless you have pre-programmed it to do so. The function has to be done while the mobile module is in the Debo Alarm System. You do not have to pre-program the carbon monoxide function to work.

3. The Debo Alarm System's Motion Detector need to placed in areas an intruder will cross to gain access to the rest of your dwelling. You can set the motion detectors to monitor specific areas in your dwelling while you are at or away from home. The motion detector can signal you when someone is driving down your driveway. The outdoors motion detectors can be placed around your property. When the motion detector's laser is broken the Debo Alarm System can be set to signal or sound. The outdoors motion detectors can be used to set a camp site perimeter and the mobile module is set to monitor. The outdoors motion detectors are solar powered and the mobile module can be recharged by the outdoors detectors just plug it in. You can set how sensitive the monitor detectors are with the sensitivity switch. Top view of the Motion Detector's Adaptor. Stick to the back of the motion detector to fit in the corner of a room.

4. The Debo Alarm System's Base is placed in the central most light socket area. The Base is install and connected the same way you install and connect a light switch. The Base has a internal rechargeable battery in case the power in your home goes out. The Debo Alarm System will still work without power.

5. The Debo Alarm System's Magnet and Receivers Monitors. The Debo Alarm System's Monitors are mounted on the designated windows and doors you are trying to secure. When mounting the monitors one goes on the window and window frame, door and door frame. The monitors need to be touching when mounted. When the monitors are separated the alarm will be triggered. The monitors can placed on your front and back gate. When someone opens your gate the Debo Alarm System will alert you.

6. The Debo Alarm System's Magnet and Receivers Monitors. The Debo Alarm System's Monitors are mounted on the designated windows and doors you are trying to secure. When mounting the monitors one goes on the window and window frame, door and door frame. The monitors need to be touching when mounted. When the monitors are separated the alarm will be triggered. The monitors can placed on your front and back gate. When someone opens your gate the Debo Alarm System will alert you.

8. The Perimeter Sensor for the Debo Alarm System can be used to setup a perimeter around your House, Worksite, Campsite etc. . . . The Perimeter Sensor has Solar Panel to keep the sensor working on its own power source. The Perimeter Sensor has a rechargeable battery so it will work at night. The Perimeter Sensor has an AC/DC adapter so you can charge the mobile module or your cell phone when you are camping. The Perimeter Sensor has enough power to charge a Laptop computer when the sun is out. When you setup your perimeter the side light will blink. Push and hold the Set Perimeter Button, when the side light stops blinking the laser is on the eye of the receiver. Setup four or more Perimeter Sensor until you are satisfied that you are secure. When the laser is broken the mobile module is triggered. You can setup the Perimeter Sensor use the motion detector function. When the side light stops blinking when setup push the Set Perimeter Button again and the light goes off. When the side light goes off the motion detector function is working. When the motion detector is tripped the mobile module will alert you.

The Debo Alarm System Second Phase (D.A.S.S.P.) is easy to install.
Locate the central most light socket in your apartment, house, business etc. . . .
Turn off the power from the main switch on your breaker box.
Check the designated light switch to see if the power is off. Once the light switch confirms that the power is off, remove the light switch was located
Place the base of the D.A.S. where the light switch was located.
Turn on the power from the main switch on your breaker box.
Place the D.A.S.S.P monitors on the desired doors and windows in your apartment, house, business etc. . . .
Place the monitor magnets on the doors or door frames and windows or window frames.
Place the monitor receivers on the doors or door frames and windows or window frames.
The monitors can be placed on your front or back gate to alert you when opened.
The monitors can be placed on your garage door to alert you or the authorities when opened.
Make sure the monitor magnets and receivers are touching. When the door, window or gate is opened the receiver separates from the magnet, then the alarm is triggered.
Place the D.A.S.S.P. keypad in the D.A.S. base and the keypad will light up indicating the D.A.S.S.P. is ready to be setup for service.
Hold the re-set button until the keypad blinks twice. When it blinks twice it is indicating it is ready for you to enter your information.
The D.A.S.S.P. has a touch screen keypad to make it easy for you to enter your information.
The alarm code can be up to 8 characters. For example: (1234safe).
The security code can be your mother's maiden name, your favorite movie etc. . . .
You can enter how many people living in the dwelling.
You can enter up to three phone number in case of an emergency.
You can enter in your address and location if you live upstairs in a multiplex.
After you are finished entering your information push enter then push and hold the re-set button. When the keypad beeps it is indicating your information has been saved.
The D.A.S.S.P. will ask you if you are ready to setup your motion detectors and your perimeter sensor (If perimeter sensors are applicable). After placing the detectors in their desired locations push and hold the re-set button. The D.A.S.S.P. will tell you the motion detectors are set. After placing the perimeter sensor around your property in its desired locations push and hold the re-set button. The D.A.S.S.P. will tell you the perimeter sensors are set.
After you have setup the D.A.S.S.P. test to see if your alarm system is working. After checking doors, widows, motion detectors, perimeter sensors and lights on/off, check the 911 function. The 911 function should display all of your information onto the 911 operators terminal. Make sure you indicate to the 911 operators you are checking your new D.A.S.S.P. and give them security code. Ask the 911 operator did your information display onto their terminal. If not, repeat the steps and re-enter your informatio.

1. Debo Alarm System Second Phase (D.A.S.S.P.) is a mobile Security System for the Home, Apartment, RV, Commercial Businesses , Vacation Suite etc. . . . This alarm system is unique because it utilizes the existing wiring in the area you are trying to secure.

2. The Debo Alarm System Second Phase Base is placed in the central most light socket area. The Base is install and connected the same way you install and connect a light switch. The Base has a internal rechargeable battery in case the power in your home goes out. The Debo Alarm System Second Phase Keypad is placed in the Base of the system.

3. The Debo Alarm System Second Phase Keypad is the central function of the alarm system. The Debo Alarm System Second Phase Keypad allows you to enter your information so it can be displayed on the 911 operators terminal. You can enter the number of people living in the dwelling. You can enter a safety code and three phone numbers to be contacted in case of an emergency. The unique feature of entering your specific location is important to your security. If you live in a multiplex, you can enter your specific apartment location. You can indicate if you live on the bottom, top, right-side, left-side or next to a structure. The Debo Alarm System Second Phase has a detachable Mobile Module.

4. The Mobile Module allows you to monitor, arm and disarm the Debo Alarm System. The Debo Alarm System Second Phase Mobile Module has 911 and Carbon Monoxide function. The Mobile Module can be plugged into a wall socket like a cell phone. The Mobile Module has a internal rechargeable battery to allow a wide range of security functions. The Mobile Module can be used to protect you and your family while you are on vacation. Place monitors on the windows and doors you want to secure. Push and hold the monitor set button like you would do a Bluetooth. When the Mobile Module beeps the device is ready to protect. The motion detectors and receiver, magnet monitor can be used at the second location with the Mobile Module.

5. The Debo Alarm System Second Phase Monitors are mounted on the designated windows and doors you are trying to secure. When mounting the monitors one goes on the window and window frame, door and door frame. The monitors need to be touching when mounted. When the monitors are separated the alarm will be triggered.

6. The Debo Alarm System Second Phase incorporates Motion Detectors. The Debo Alarm System's motion detector need to placed in areas an intruder will cross to gain access to the rest of your dwelling. You can set the motion detectors to monitor specific areas of your dwelling while you are at or away from home. The Motion Detector has high, medium and low sensitivity settings. The motion detector has an adaptor. The Adaptor is stuck to the back of the Motion Detector to fit in the corner of a room.

7. The Debo Alarm System Second Phase Perimeter Sensors are placed around your property. When the Perimeter Sensor's laser is broken it alerts the system. The Perimeter Sensor can alert you to a car driving up your driveway. The Perimeter Sensors has an internal battery recharged by solar panel located on top of the sensor. The Perimeter Sensor can be used at a campsite with your Mobile Module. The Mobile Module can be recharged by the Perimeter Sensor by plugging it into the AC/DC Adapter.
